(19) United States
(12) Patent Application Publication
(10) Pub. No.: US 2016/0035253 A1
(43) Pub. Date: Feb. 4, 2016

(54) MODULAR CARD DISPLAY DEVICE

(71) Applicant: L.E. ELLIOTT CONSULTANT INC., Grenville-sur-la-Rouge (CA)

(72) Inventors: Serge Boileau, Grenville-sur-la-rouge, Quebec (CA); Linda Emily Elliott, Grenville-sur-la-rouge, Quebec (CA)

(21) Appl. No.: 14/781,319

(22) PCT Filed: Apr. 3, 2014
(86) PCT No.: PCT/CA2014/000311

§ 371 Date: Sep. 30, 2015

Related U.S. Application Data
(60) Provisional application No. 61/808,439, filed on Apr. 4, 2013.

(51) Int. Cl. G09F 1/10; A47F 5/10

(52) U.S. Cl. CPC G09F 1/10; A47F 5/10

(57) ABSTRACT

A card display device for displaying cards, the card display device comprising a number of card display segments attached to one another, each the card display segment comprising a main body, a first connector carried by the main body, a second connector carried by the main body, complementary first and second angular adjustment members provided on the first and second connectors, and a card support member carried by one of the main body, the first connector and the second connector for holding a card for display. One card display segment is attached to another card display segment by connecting its first connector to the second connector of the other card display segment and by angularly adjusting its position relative to the position of the other card display segment by using the angular adjustment members.

### CROSS-REFERENCE DATA

The present application claims the priority of U.S. provisional patent application No. 61/808,439 filed on Apr. 4, 2013.

### FIELD OF THE INVENTION

The present invention relates to card display devices, and more particularly to a modular card display device.

### BACKGROUND OF THE INVENTION

Retail stores and individuals can use card display devices that hold and display cards. Cards to be displayed may include gift cards, birthday or anniversary cards, collectable cards (e.g. baseball cards), pictures, promotional material displayed on a paper sheet, or generally any suitable item to be displayed.

Card display devices usually comprise card clips allowing the cards to be held, and a support carrying the card clip. Many such supports are self-standing and may be installed for example on a table or countertop.

Other prior devices include picture frames that can be attached to one another in an array of frames aligned in specific non-adjustable directions.

No prior art card display device known to applicant provides for the flexibility of being arranged in a wide variety of different selectable arrangements.

### SUMMARY OF THE INVENTION

The present invention relates to a card display device for displaying cards, said card display device comprising a number of card display segments attached to one another, each said card display segment comprising:
a main body;
a first connector carried by said main body;
a second connector carried by said main body;
first and second complementary angular adjustment members respectively provided on said first and second connectors; and
at least one card support member carried by one of said main body, said first connector and said second connector, each said at least one card support member for holding a card for display;

wherein one said card display segment is attached to another card display segment by connecting its said first connector to said second connector of said another card display segment and by angularly adjusting its position relative to the position of said another card display segment by using said first and second angular adjustment members.

In one embodiment, said first and second connectors are connected through a snap-fit engagement.

In one embodiment, said first and second angular adjustment members comprise complementary ribs provided on both said first and second connectors providing a series of discrete relative angular positions between said one card display segment and said another card display segment.

In one embodiment, said card display segments are attached in end-to-end fashion.

In one embodiment, said at least one card support member is carried by said main body.

In one embodiment, said card display device further comprises attachment members for attaching said card display device to a support structure.

In one embodiment, said attachment members comprise openings provided in said first and second connectors for receiving a fastener therethrough.

The present invention also relates to a card display segment for use in forming a card display device for displaying cards, comprising:
a main body;
a first connector carried by said main body;
first angular adjustment members provided on said first connector; and
at least one card support member carried by one of said main body and said first connector, each said at least one card support member for holding a card for display;

wherein said card display segment is attachable to another card display segment by connecting its said first connector to said another card display segment and by angularly adjusting its position relative to the position of said another card display segment by using said angular adjustment members.

In one embodiment, said card display segment further comprises a second connector carried by said main body, and second angular adjustment members provided on said second connector that are complementary to said first angular adjustment members.

The present invention further relates to a method of arranging a number of card display segments to form a card display device, each said card display segment comprising a main body, a first connector carried by said main body, a second connector carried by said main body, first and second complementary angular adjustment members provided on said first and second connectors and at least one card support member carried by one of said main body, said first connector and said second connector, each said at least one card support member for holding a card for display, said method comprising the steps of:
attaching said first connectors of some said card display segments to said second connectors of other said display segments; and
angularly adjusting the relative angular positions of said some card display segments and said other card display segments by using of said first and second angular adjustment members, wherein said number of card display segments will be attached to one another at selected relative angles to form said card display device.

### DESCRIPTION OF THE DRAWINGS

In the annexed drawings:

FIG. 1 is a front elevation of a card display device according to a first embodiment of the present invention, with three cards being held and displayed by the card display device;

FIGS. 2, 3 and 4 are respectively a front, a side and a rear elevation of a card display segment used to form the card display device of FIG. 1, at an enlarged scale;

FIG. 5 is a partial front elevation of three interconnected card display segments of the card display device of FIG. 1, with one card display segment holding a card for display;

FIG. 6 is a partial enlarged cross-sectional view taken along line VI-VI of FIG. 5, further showing a thumbtack engaging the first and second connectors of the two interconnected card display segments;

FIG. 7 is a partial enlarged cross-section view taken along line VII-VII of FIG. 5;

FIGS. 8 and 9 are respectively an enlarged front perspective view and an enlarged rear perspective view showing the extremities of two card display segments of the card display device of FIG. 1 to be attached to each other, with a thumbtack;

FIG. 10 is a front elevation, at a smaller scale, of two interconnected card display segments as shown in FIGS. 2-4, showing in phantom lines arbitrary alternate angular positions among many possible alternate angular positions of one card display segment relative to the other;

FIGS. 11 and 12 show alternate arrangements of card display segments to form alternate card display devices, with FIG. 11 being a partial view only, according to the embodiment of the card display segment shown in FIGS. 2-4;

FIGS. 13 and 14 are respectively a top perspective view and a side elevation of a card display segment according to another embodiment of the invention;

FIGS. 15 and 16 are respectively a top and a bottom partial perspective view of the extremities of two card display segments according to the embodiment shown in FIGS. 13 and 14 to be attached to each other, with a thumbtack; and

FIGS. 17 and 18 are similar to FIGS. 13 and 14, but show a card display segment according to yet another embodiment of the invention.

### DETAILED DESCRIPTION OF THE EMBODIMENTS

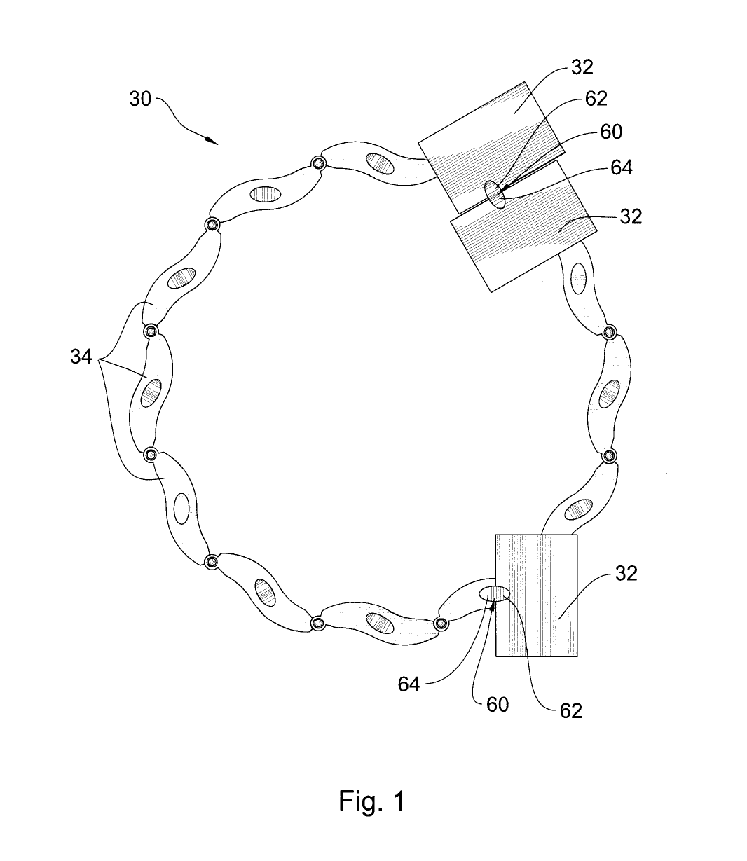

FIG. 1 shows a card display device 30 according to one embodiment of the present invention. The purpose of card display device 30 is to hold one or more cards 32 for display. Card display device 30 may advantageously be attached to a wall or other support structure (not shown).

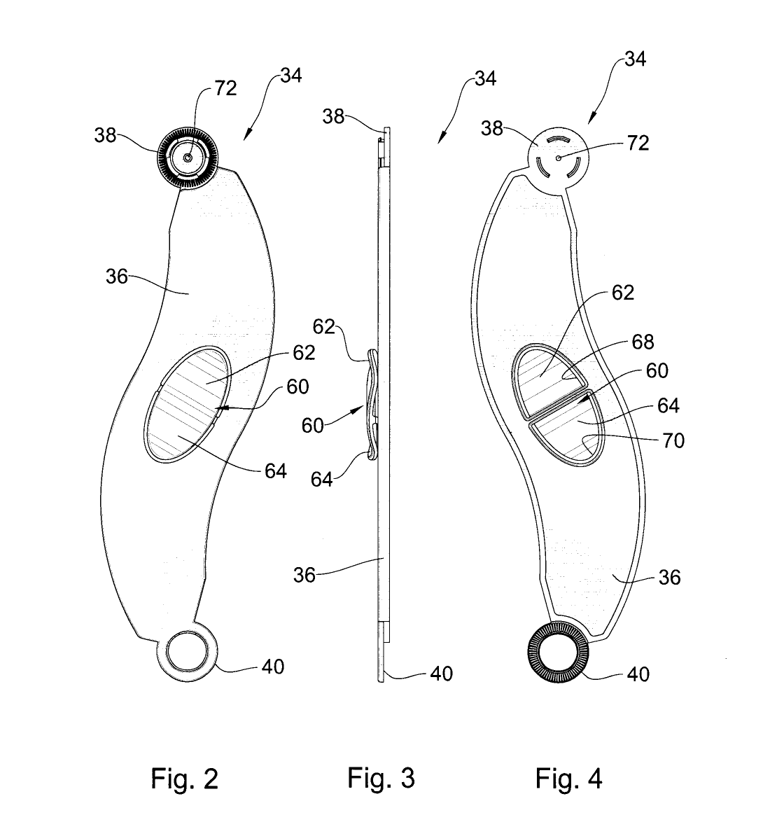

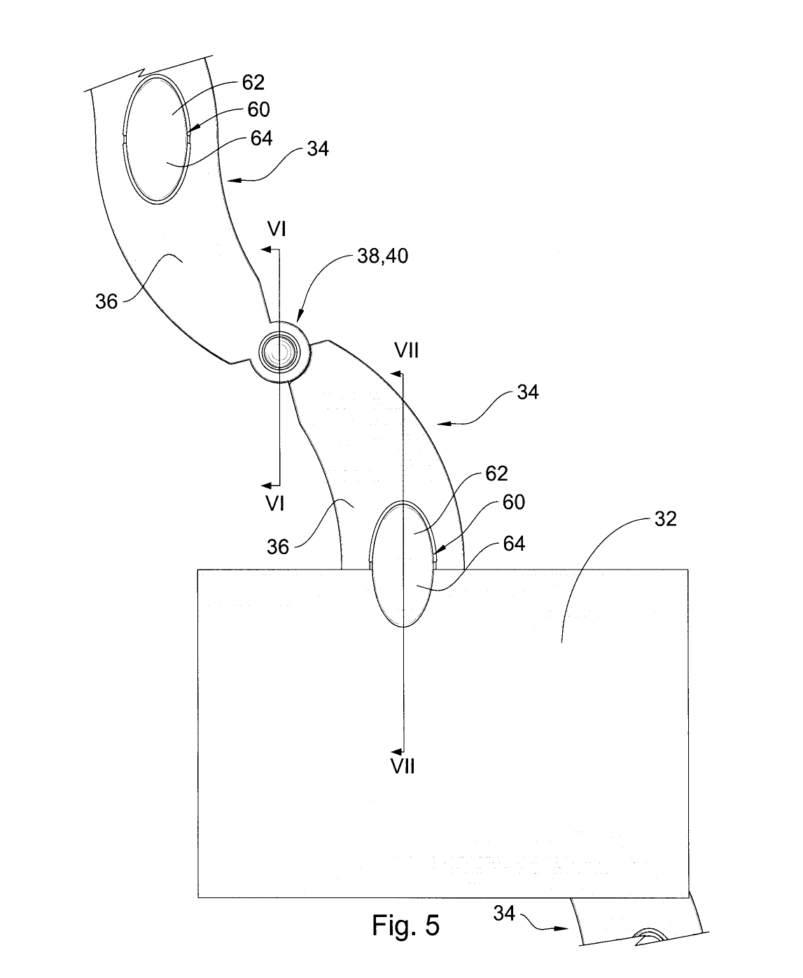

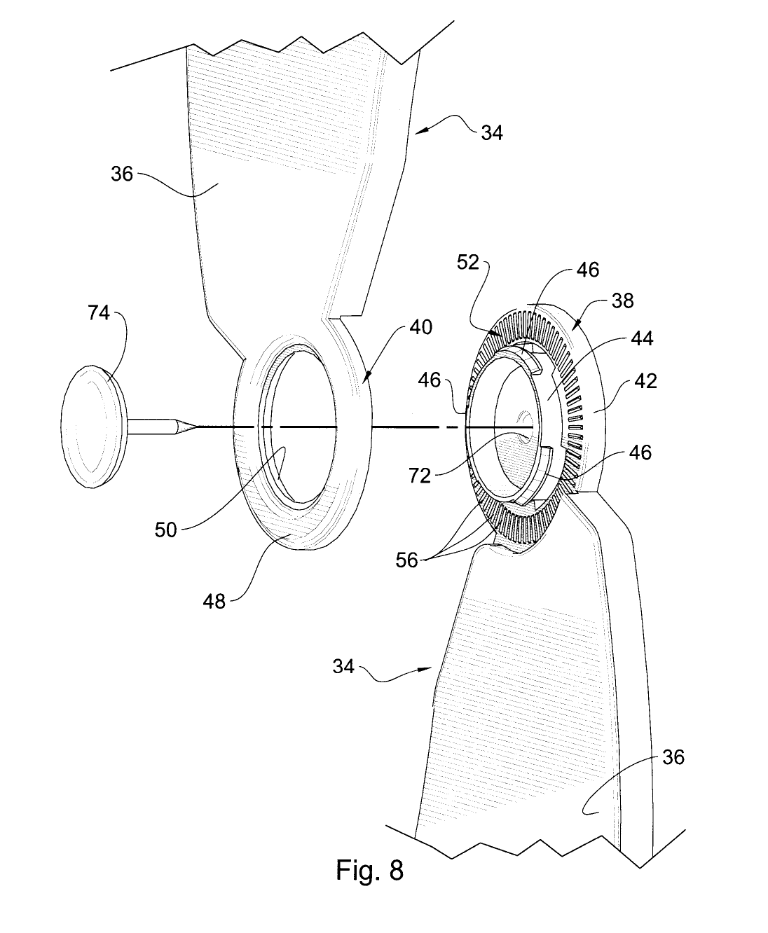

More particularly, FIGS. 1-9 show that card display device 30 comprises a number of card display segments 34 attached to one another in end-to-end fashion.

Each card display segment 34 comprises a main body 36 that has a generally flat and elongated shape. First and second connectors 38, 40 are carried by main body 36 and are located at opposite first and second extremities of elongated main body 36. More specifically, first and second connectors 38, 40 and main body 36 are formed integrally as a unitary piece of molded plastic, although alternate embodiments could include connectors made distinctly from the main body and other materials being used for either the connectors 38, 40 and/or main body 36.

Connectors 38, 40 are used to attach card display segments 34 to one another in a snap-fit engagement.

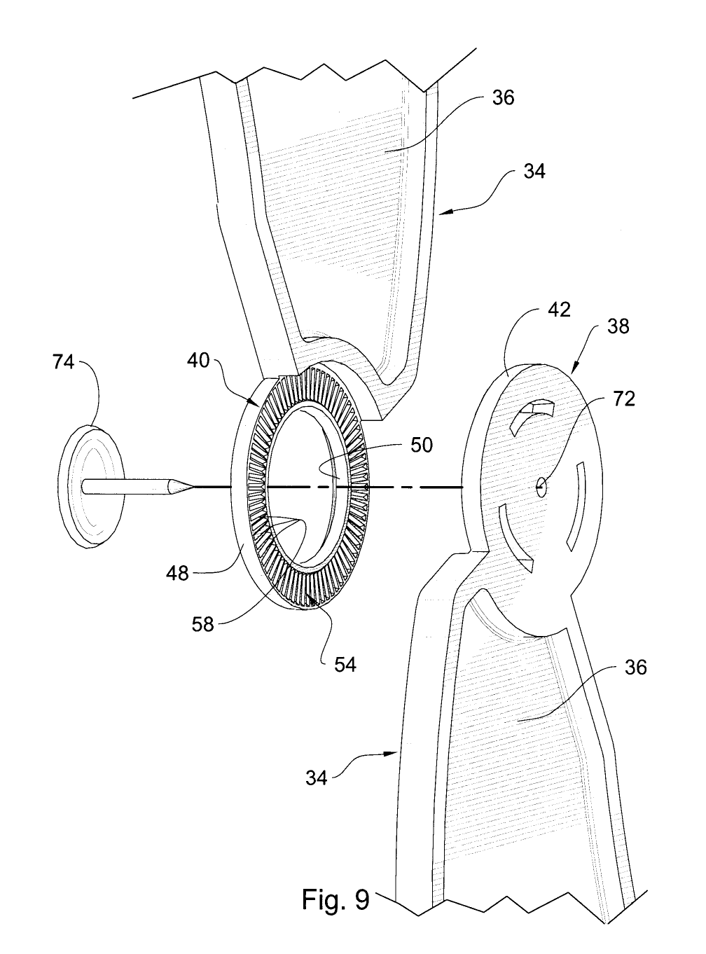

FIGS. 8 and 9 show that first connector 38 comprises a discoid base 42 from which an annular resiliently deformable attachment wall 44 extends. Attachment wall 44 is equipped with three attachment tabs 46 that radially project outwardly from attachment wall 44.

Second connector 40 comprises an annular body 48 defining a central opening 50 therein. Central opening 50 is sized to allow attachment wall 44 to slide therein. More specifically, central opening is diametrically larger than attachment wall 44, but is diametrically smaller than the outer circumference of attachment tabs 46. Consequently, upon being forced into opening 50, the bevelled leading edges formed on attachment tabs 46 will slide against the inner surface of annular body 48 within opening 50, forcing attachment wall 44 to resiliently deform inwardly until tabs 46 snap back outwardly into position when they protrude beyond annular body 48. The flat trailing edges of tabs 46 will then abut against annular body 48, preventing accidental egress thereof through opening 50. First and second connectors 38, 40 are thereby attached to each other.

To disengage the first and second connectors 38, 40 from each other, tabs 46 are forced inwardly, with attachment wall 44 consequently resiliently deforming inwardly, until tabs 46 and attachment wall 44 are allowed to slide out through the central opening 50 of second connector annular body 48.

Card display segments 34 also each comprise angular adjustment members 52, 54 provided on first and second connectors 38, 40. More particularly, angular adjustment members 52, 54 are respectively in the form of ribs 56 and 58 that are respectively provided on the first connector base 42 and on the second connector annular body 48.

The space between the bottom edges of attachment tabs 46 and discoid base 42 of first connector 38 is sized such that, when first and second connectors 38, 40 of two card display segments 34, 34 are attached to each other, the annular body 48 of the second connector 40 will fit snugly between attachment tabs 46 and annular body 42. More particularly, the ribs 56, 58 of first and second connectors will be forced to intermesh in between each other, i.e. the ribs 56 of first connector 38 will fit between ribs of second connector 40, and vice versa. The inter-abutment of ribs 56 and 58 helps prevent spontaneous rotation of the two attached card display segments 34, 34 under normal use, e.g. under the effect of gravity or casual handling of card display segments 34, 34.

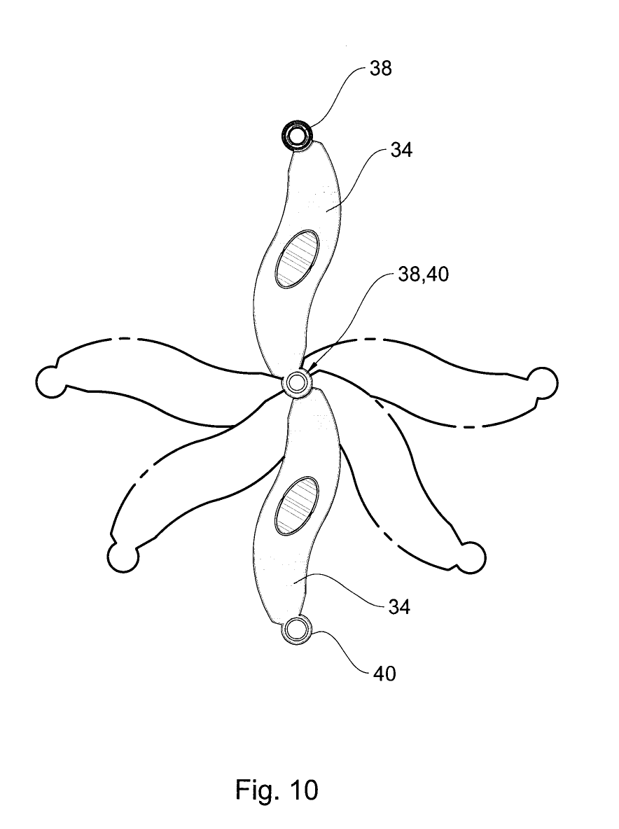

It is possible to adjust the angular position of the two thusly attached card display segments 34, 34 by forcing them to rotate about the attached first and second connectors 38, 40, against the resistance offered by the intermeshed ribs 56, 58. The attachment tabs 46 will resiliently yield when ribs 56, 58 are moved over one another, to allow the position of the two attached card display segments 34, 34 to be angularly adjusted. FIG. 10 suggests how two card display segments 34, 34 may have different angular positions relative to each other by showing in phantom lines a few among the many different angular positions that one card display segment 34, for example the bottom card display segment 34, may have with respect to the other card display segment 34, for example the top card display segment 34.

Each card display segment 34 further comprises at least one card support member 60 carried by main body 36. Card support member 60 comprises a pair of tongues 62, 64 that extend substantially parallel to although spacedly from main body 36. Tongues 62, 64 are located approximately centrally between the first and second connectors 38, 40. A tongue support wall 66 attaches tongues 62, 64 to main body 36. Holes 68, 70 are formed within main body 36 underneath tongues 62, 64, mainly for production purposes. Tongues 62, 64 are formed integrally with wall 66 and main body 36, and extend on either side of wall 66. Each tongue 62, 64 may be used to hold one or more cards 32 for display, by inserting a card 32 or a stack of cards 32 between tongues 62, 64 and main body 36 as shown in FIGS. 1, 5 and 7. Tongues 62, 64 resiliently yield to move away from main body 36 to allow insertion of one or more cards 32 between tongues 62, 64 and main body 36.

In an alternate embodiment, card support member 60 could be carried by one of the first and second connectors 38, 40 instead of by main body 36.

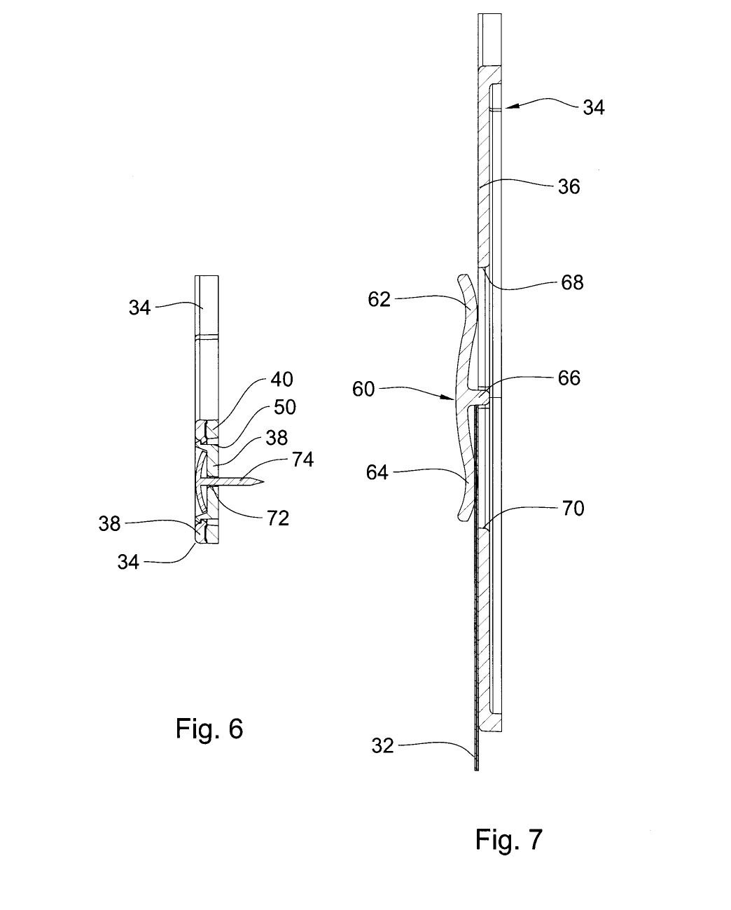

First connector 38 of card display segment 34 further comprises a central opening 72. First connector central opening 72 and second connector opening 50 form attachment members allowing card display device 34 to be attached to a wall or other suitable support structure. A thumbtack 74, or other equivalent fastener, may engage a pair of attached first and second connectors 38, 40 as shown in FIGS. 6, 8 and 9 to attach card display device 30 to a wall. As shown, the second connector opening 50 is sized to receive therein the head of thumbtack 74, while the first connector opening 72 is sized to receive therein the shaft of thumbtack 74.

One or more thumbtacks 74 may be used for this purpose on respective pairs of attached first and second connectors 38, 40 of card display device 30.

The attachment members could alternately be formed elsewhere than on the connectors, such as on main body 36.

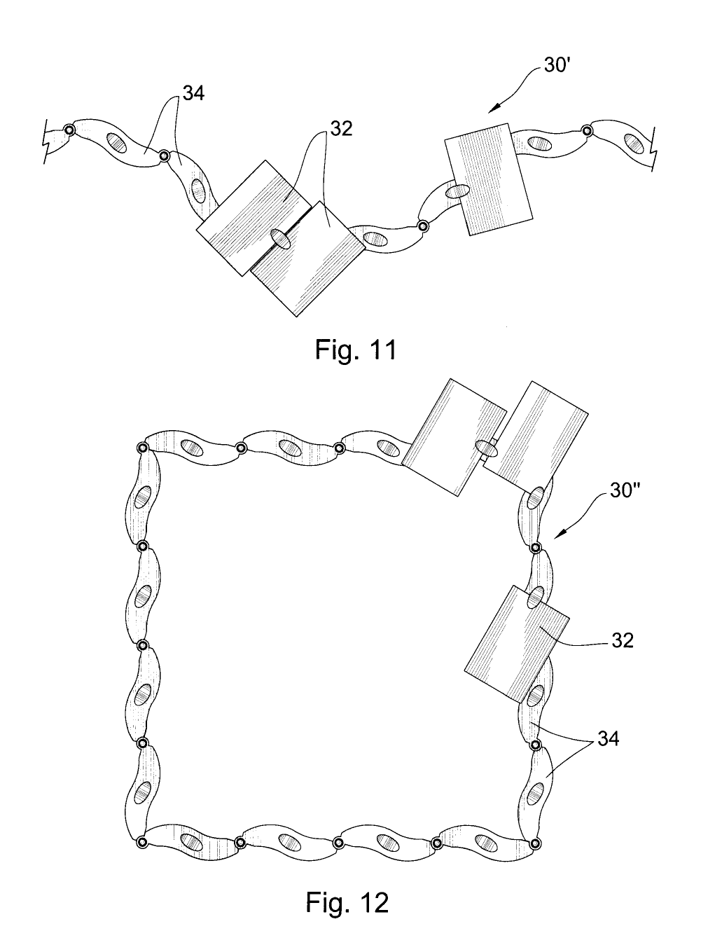

While FIG. 1 shows one arrangement of interconnected card display segments for forming a card display device 30 having an essentially circular pattern, it will now be readily understood that a selected number of card display segments 34 may be arranged differently, according to each user's preferences, to form card display devices of varying shapes. For example, FIGS. 11 and 12 show alternate arrangements of card display segments 34 for forming alternate card display devices 30′ and 30″, respectively a first alternate card display segment 30′ that forms a sinuous line (shown only partly in FIG. 11) and a second alternate card display segment 30″ that forms a square shape. To support any given card display device 30, 30′ or 30″, one or more thumbtacks 74 could be used. For example, it is envisioned that a single thumbtack could be used to support the entire card display device 30 of FIG. 1, a number of spaced-apart thumbtacks could be used to support the sinuous card display device 30′ of FIG. 11 and a pair of thumbtacks could be used to support the rectangular display device 30″ of FIG. 12 (one at each corner).

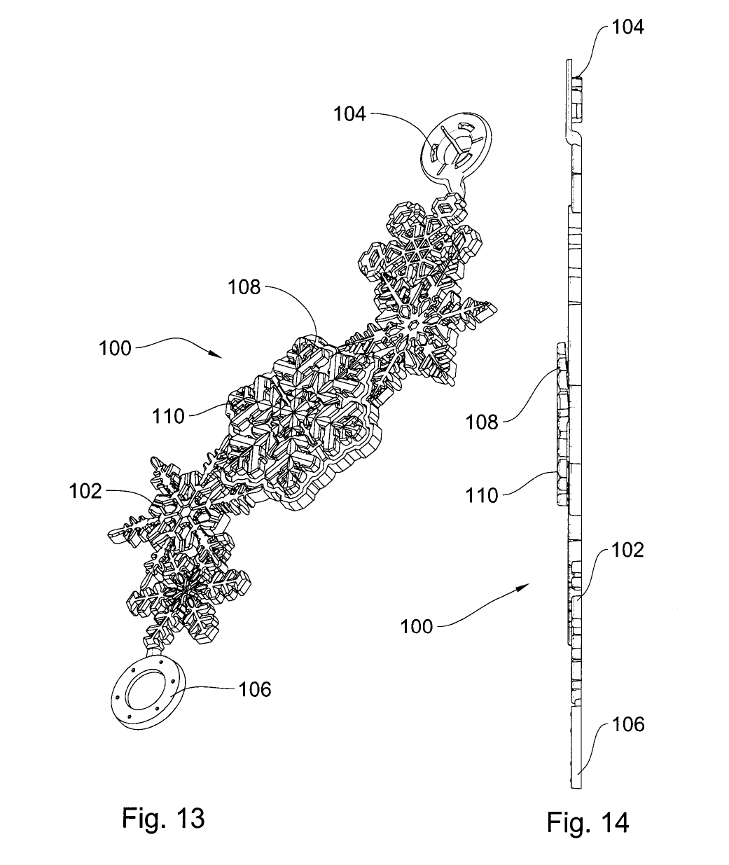

FIGS. 13-14 show another embodiment of a card display segment 100 that is similar to the card display segment 34 shown in FIGS. 1-12 except as noted hereinafter.

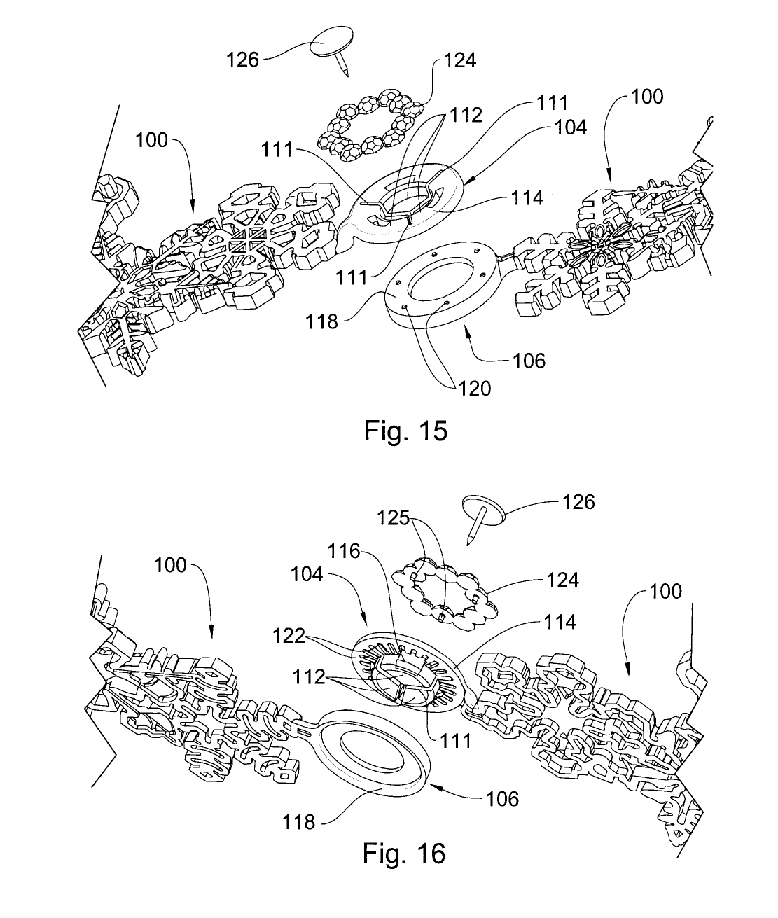

Card display segment 100 comprises a generally flat and elongated main body 102 that carries first and second connectors 104, 106 at opposite extremities thereof. First and second connectors 104, 106 are complementary so that two card display segments 100, 100 may be attached to each other in end-to-end fashion by attaching the first connector 104 of one card display segment 100 to the second connector 106 of another card display segment 100, as suggested in FIGS. 15-16. A pair of tongues 108, 110 are carried by main body to hold one or more cards (not shown) for display. The cards are to be held between tongues 108, 110 and main body 102. In this, card display segment 100 of this alternate embodiment is similar to card display segment 34.

The appearance of card display segment 100 differs from that of card display segment 34. Indeed, main body 102 is formed in the likeness of interconnected snowflakes, and the tongues 108, 110 are formed like the two halves of a same snowflake that overlies main body 102.

First connector 104 comprises three slots 111 that diverge from a central point thereof to form independently resiliently movable projections 112 that extend centrally away from an annular main body 114. Attachment tabs 116, similar to attachment tabs 46 of the first embodiment, are carried by each projection 112 spacedly from main body 114.

Second connector 106 comprises an annular main body 118 that can be inserted between the first connector attachment tabs 116 and main body 114, to attach the first and second connectors to each other, similarly to how the first and second connectors 38, 40 of the card display device 34 are inter-connectable.

Second connector 106 comprises angular adjustment members in the form of pins 120 on one face of its main body 118. Pins 120 will cooperate with further angular adjustment members in the form of slots 122 provided on an opposed face of first connector 104 to allow relative angular adjustment of two attached card display segments 100, 100. More specifically, the relative position of two attached card display segments 100, 100 may be angularly adjusted by having pins 120 engage selected slots 122. Movement of pins from one slot to the next requires the movable projections 112 to resiliently deform to accommodate the displacement.

FIGS. 15 and 16 further show that an annular decorative ring 124 is attachable to first connector 104 to partly conceal first connector 104 thereunder. Pins 125 project from to decorative ring 124 for engagement within slots 111 of first connector 104. A thumbtack 126 is used to attach the card display segments 100, 100 to a support structure, as in the first embodiment, and annular decorative ring 124 is sized to accommodate the head of thumbtack 126.

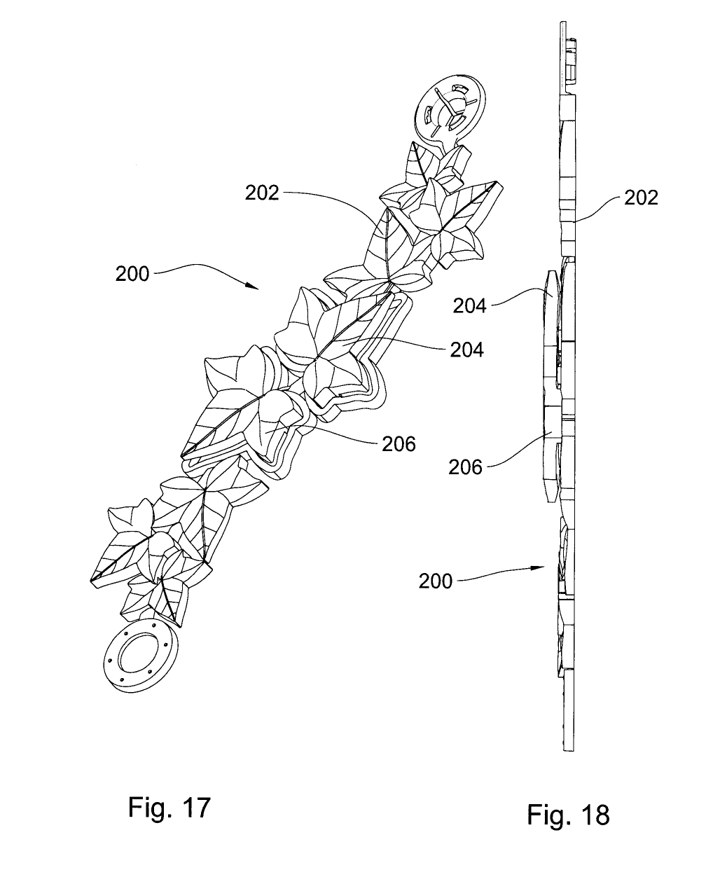

A third embodiment of a card display segment 200 is shown in FIGS. 17 and 18 which is similar to the second embodiment 100, except that the main body 202 and the tongues 204, 206 of card of card display segment 200 are formed in the likeness of ivy leaves instead of in the likeness of snowflakes.

According to another embodiment of the present invention (not shown), the card display segments comprise connectors located at intermediate positions between the first and second ends of the support structure, and not at its extremities.

According to another embodiment of the present invention (not shown), the card display segments comprise hybrid male-female connectors so that any end of a given display segment can be connected to any end of any other display segment. Furthermore, three or more hybrid connectors can be stacked at the same connection point to form branches stemming from a central node, enabling a diversity of planar arrangements.

Another embodiment (not shown) comprises a single card support member per display segment, or more than two card support members.

According to yet another embodiment (not shown), the card display segments comprise different card support members than that shown and described hereinabove. For example, other types of paper clips, concealed under and attached to decorative elements of the display segment, could be used instead of the card support members shown and described herein.

Other embodiments (not shown) comprise card display segments of different sizes and lengths, and with different decorative patterns.

Other embodiments (not shown) comprise some card display segments with a single connector (end segments), and some connectors with more than two connectors (hub segments), with the end segments being attached to the hub segments.

Other embodiments use different connectors wherein the angular relationship may be set based on friction, so that any two display segments can be placed at any given non-discrete angle relative to each other; instead of having intermeshed ribs or pins, as shown and described herein.

The first and second connectors referred herein consequently refer to connectors that may be different from each other as described above, or identical; but in any event enable the attachment of the card display segment to one or more other card display segments.

Alternate fasteners can be used instead of thumbtacks to attach a card display device to a wall. For example, double-sided adhesive foam pads could be positioned between the wall and the card display device.

1. A card display device for displaying cards, said card display device comprising a number of card display segments attached to one another, each said card display segment comprising:
a main body;
a first connector carried by said main body;
a second connector carried by said main body;
first and second complementary angular adjustment members respectively provided on said first and second connectors; and
at least one card support member carried by one of said main body, said first connector and said second connector, each said at least one card support member for holding a card for display;
wherein one said card display segment is attached to another card display segment by connecting its said first connector to said second connector of said another card display segment and by angularly adjusting its position relative to the position of said another card display segment by using said first and second angular adjustment members.

2. A card display device as defined in claim 1, wherein said first and second connectors are connected through a snap-fit engagement.

3. A card display device as defined in claim 1, wherein said first and second angular adjustment members comprise complementary ribs provided on both said first and second connectors providing a series of discrete relative angular positions between said one card display segment and said another card display segment.

4. A card display device as defined in claim 1, wherein said card display segments are attached in end-to-end fashion.

5. A card display device as defined in claim 1, wherein said at least one card support member is carried by said main body.

6. A card display device as defined in claim 1, further comprising attachment members for attaching said card display device to a support structure.

7. A card display device as defined in claim 6, wherein said attachment members comprise openings provided in said first and second connectors for receiving a fastener therethrough.

8. A card display segment for use in forming a card display device for displaying cards, comprising:
a main body;
a first connector carried by said main body;
first angular adjustment members provided on said first connector; and
at least one card support member carried by one of said main body and said first connector, each said at least one card support member for holding a card for display;
wherein said card display segment is attachable to another card display segment by connecting its said first connector to said another card display segment and by angularly adjusting its position relative to the position of said another card display segment by using said angular adjustment members.

9. A card display segment as defined in claim 8, further comprising a second connector carried by said main body, and second angular adjustment members provided on said second connector that are complementary to said first angular adjustment members.

10. A card display segment as defined in claim 9, wherein said first and second angular adjustment members comprise complementary ribs provided on both said first and second connectors.

11. A card display segment as defined in claim 9, wherein said first angular adjustment member comprises slots provided on said first connector and said second angular adjustment member comprises pins provided on said second connector, said pins being complementary to said slots.

12. A card display segment as defined in claim 9, wherein said at least one card support member is carried by said main body.

13. A card display segment as defined in claim 9, further comprising attachment members for attaching said card display device to a support structure.

14. A card display segment as defined in claim 13, wherein said attachment members comprise openings provided in said first and second connectors for receiving a fastener therethrough.

15. A method of arranging a number of card display segments to form a card display device, each said card display segment comprising a main body, a first connector carried by said main body, a second connector carried by said main body, first and second complementary angular adjustment members provided on said first and second connectors and at least one card support member carried by one of said main body, said first connector and said second connector, each said at least one card support member for holding a card for display, said method comprising the steps of:
attaching said first connectors of some said card display segments to said second connectors of other said display segments; and
angularly adjusting the relative angular positions of said some card display segments and said other card display segments by using of said first and second angular adjustment members, wherein said number of card display segments will be attached to one another at selected relative angles to form said card display device.
